(19) United States
(12) Patent Application Publication
(10) Pub. No.: US 2026/0316643 A1
(43) Pub. Date: Oct. 15, 2026

(54) Method of Using Excess Substrate From a Comfort System of a Vehicle Seat into Another Comfort System for a Vehicle Seat

(71) Applicant: GENTHERM INCORPORATED, Novi, MI (US)

(72) Inventors: Andrew Charles White, Greenville, SC (US); Randy Kent Lewis, Greenville, SC (US); Luke Andrew Boeve, Royal Oak, MI (US); Ricardo Edmundo Flores Gonzalez, Novi, MI (US); Joseph Krzemien, Belle River, CA (US); Igor Spasojevic, BelleRiver, CA (US); William Hardin Goodman, Fountain Inn, SC (US)

(21) Appl. No.: 19/484,421

(22) PCT Filed: Jul. 24, 2024
(86) PCT No.: PCT/US2024/039306

§ 371 Date: Nov. 14, 2025

Related U.S. Application Data
(60) Provisional application No. 63/528,676, filed on Jul. 25, 2023.

(51) Int. Cl. B60N 2/56; B60N 2/66; B60N 2/90

(52) U.S. Cl. CPC B60N 2/56; B60N 2/665; B60N 2/976

(57) ABSTRACT

A method of making a comfort system for a vehicle seat, the method includes providing a substrate for making a first comfort system; separating the substrate into a usable substrate and an excess substrate; using at least a portion of the usable substrate to make the first comfort system for the vehicle seat; and using at least a portion of the excess substrate to make a second comfort system for the vehicle seat or for another vehicle seat.

### CROSS-REFERENCE TO RELATED APPLICATIONS

This application claims priority to U.S. 63/528,676 filed on Jul. 25, 2023, the entirety of which is hereby incorporated by reference herein for all purposes.

### FIELD

These teachings relate to a method of using or repurposing or reclaiming excess substrate from a comfort system of a vehicle seat into another comfort system for a vehicle seat. These teachings also related to a comfort system for a vehicle seat that is at least partially made from excess substrate from another comfort system of a vehicle seat.

### BACKGROUND

Some vehicle seats include one or more systems for improving occupant comfort. For example, some vehicle seats include one or more thermal systems to provide heating and/or cooling functions to an occupant of the vehicle seat. Some vehicle seats include one or more pneumatic systems to provide massage and/or lumbar functions to an occupant of the vehicle seat. While such systems are generally enjoyed by consumers, traditional methods of producing these systems may generate excess material or scrap, which may undesirably increase material costs and negatively affect the environment. It may therefore be desirable to improve the current state of the art.

### SUMMARY

These teachings relate to a comfort system for a vehicle seat and to a method of making one or more comfort systems. These teachings relate generally to collecting, saving, or otherwise obtaining excess material from the manufacture or assembly of one comfort system and to reusing or repurposing or reclaiming the same for another comfort system for a vehicle seat. These teachings also relate to a comfort system for a vehicle seat that is made from excess materials collected or obtained from the manufacture or assembly of another comfort system for a vehicle seat.

These teachings provide a method of collecting or obtaining excess materials from the manufacture or assembly of a comfort system for a vehicle seat that would otherwise end up discarded into the trash and repurposing the same into the manufacture or assembly of another comfort system for a vehicle seat. Advantageously, these teachings may result in a substantial cost savings for the comfort system manufacturer, which may be passed onto the consumer. Moreover, these teachings may result in a substantial reduction in waste thereby benefiting the environment.

### BRIEF DESCRIPTION OF THE DRAWINGS

FIG. 1 is a side view of a vehicle and a vehicle seat.

FIG. 2 is a perspective view of a cushion of a vehicle seat.

FIG. 3 is a front view of a blank or bulk substrate for a comfort system.

FIG. 4A is a front view of a substrate for a comfort system with schematically illustrated cut lines defining usable substrate and excess substrate.

FIG. 4B is a front view of the usable substrate from FIG. 4A, where the excess substrate has been removed.

FIG. 4C is a front view of usable excess substrate removed from FIG. 4A.

FIG. 4D is a front view of the usable excess substrate from FIG. 4C that is used or repurposed into another comfort system for a vehicle seat.

FIG. 5A is a front view of a substrate for a comfort system with schematically illustrated cut lines defining usable substrate and excess substrate.

FIG. 5B is a front view of the usable substrate and usable excess substrate.

FIG. 5C is a front view of the usable excess substrate used or repurposed for another comfort system.

FIG. 5D is a front view of the usable excess substrate used or repurposed for another comfort system.

FIG. 6 illustrates a flow diagram of the method of these teachings.

FIG. 7A is a front view of a substrate for a comfort system with schematically illustrated cut lines defining usable substrate and usable excess substrate.

FIG. 7B is a front view of the usable excess substrate used or repurposed.

FIG. 7C is a side view of FIG. 7B.

### DETAILED DESCRIPTION

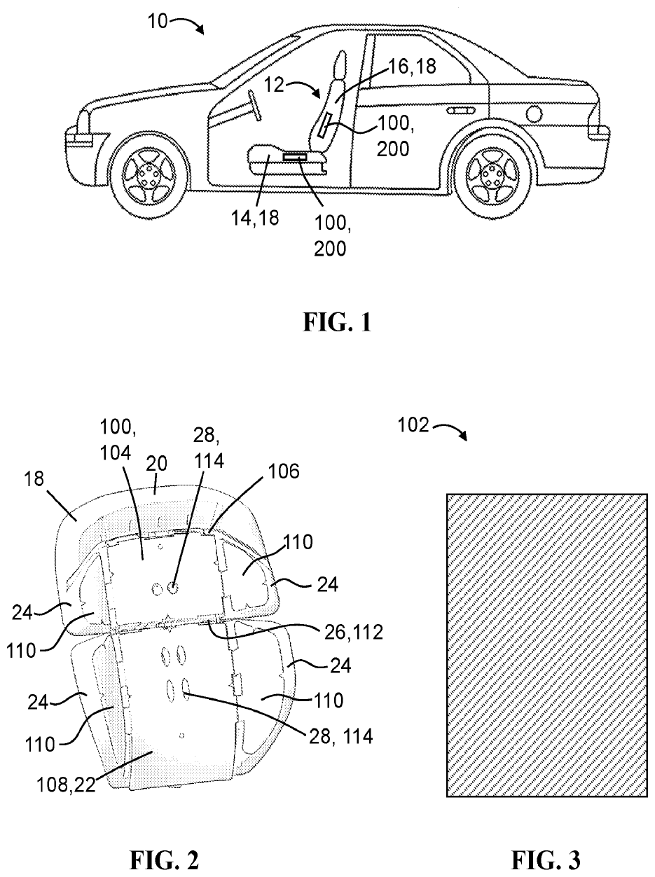

FIG. 1 illustrates a vehicle 10. The vehicle 10 comprises one or more vehicle seats 12. The vehicle seat 12 comprises a seating portion 14 and a backrest portion 16. The seating portion 14 and/or the backrest portion 16 may include a cushion 18. The cushion 18 may be a single cushion for both portions 14, 16, or the cushion 18 may be two (or more) separate pieces for one or both portions 14, 16 The vehicle seat 12, the seating portion 14, and/or the backrest portion 16 may include one or more comfort systems 100, 200. In the illustrated example, the vehicle seat 12 includes two comfort systems (i.e., 100 and 200), which may be referred to as a comfort assembly. It is understood that these teachings may provide any number of comfort systems and assemblies, including only one comfort system or assembly or any multiple of comfort systems or assemblies.

FIG. 2 illustrates a cushion 18 and a comfort system 100 (and/or 200). While the cushion 18 is illustrated as being configured for the backrest portion 16 of a vehicle seat, the features of the cushion 18 may also or instead be used without limitation for the seating portion of the vehicle seat. Therefore, the description of the cushion 18 is not limited to only the backrest portion 16 unless expressly indicated. The cushion 18 may include one or more geometries like an upper or front region 20, a lower or back region 22, one or more bolsters 24, one or more trenches 26, one or more through holes 28, one or more hog rings, etc.

A comfort system 100 may be installed on or in or below the cushion 18. For example, a comfort system 100 may be placed or attached to the A-surface of the cushion 18. In some configurations, the comfort system 100 may instead or may additionally be placed or attached to the back or B-side of the cushion 18 and/or within a thickness of the cushion 18 (between the A- and B-sides). In some configurations, the cushion 18 may be part of the comfort system.

The comfort system 100 may be configured to provide or increase occupant comfort in the vehicle seat 12. For example, the comfort system 100 may be a thermal device that is configured to generate heating and/or cooling functions. The comfort system 100 may be a heating mat configured to generate heat. The comfort system 100 may be a cooling system configured to generate cooling. The comfort system 100 may be a pneumatic system configured to provide lumbar and/or massage functions. The comfort system 100 may be an air distribution system in the form of a bag structure that expels air towards an occupant or draws air away from an occupant in the seat. The comfort system 100 may be any combinations of the comfort systems disclosed herein.

The comfort system 100 may include one or more features or geometries that generally correspond to the structure, geometry, or features of the cushion 18. For example, the comfort system 100 may have a carrier or substrate 104 (which may also be referred to herein as a usable substrate or excess usable substrate). The substrate 104 may include an upper or front region 106, a lower or rear region 108, one or more bolster regions 110, one or more cutouts 112, one or more through holes 114, or a combination thereof. As can be appreciated, at least some of these features or geometries of the substrate 104 may correspond to some of the features or geometries of the cushion 18. For example, the upper or front region 106 of the substrate 104 may be located at or adjacent or below the upper or front region 20 of the cushion 18; the lower or rear region 108 of the substrate 104 may be located at or adjacent to the lower or bottom region 22 of the cushion 18; the one or more bolster regions 110 of the substrate 104 may be located at or adjacent to the one or more bolsters 24 of the cushion; the one or more cutouts 112 of the substrate 104 may be located at or adjacent to the one or more trenches 26 of the cushion or between upper and lower bolsters 24 of the cushion 18; the one or more through holes 114 of the substrate 104 may be located at or adjacent to the one or more through holes 28 of the cushion 18; etc. By corresponding these substrate 104 and cushion 18 features, the comfort system 100 may lay flat on the cushion and therefore prevent bunching or bulging of the comfort system 100 on the cushion 18.

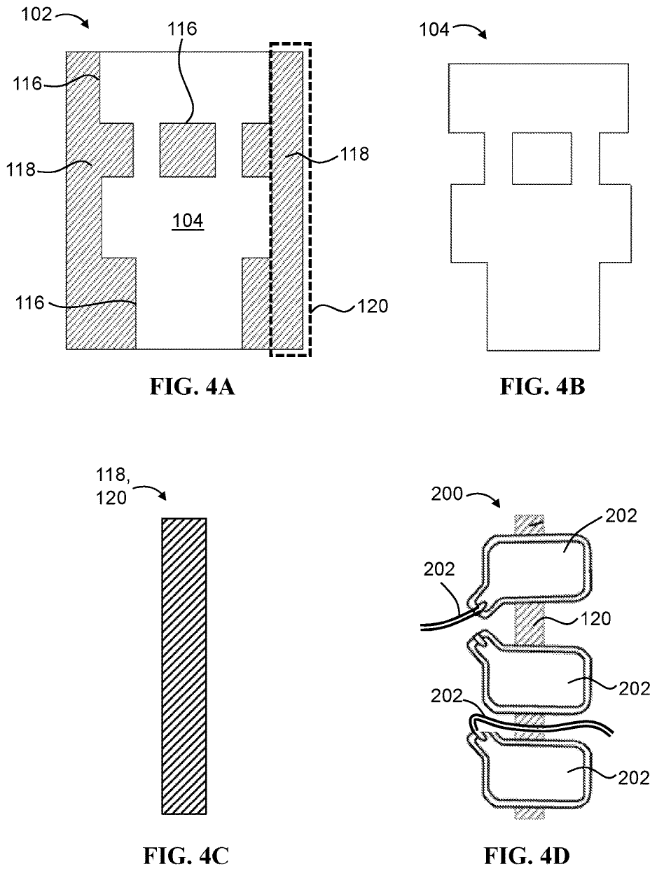

FIG. 3 illustrates a blank or bulk carrier or substrate 102. The blank or bulk substrate 102 may be supplied in a roll or in pre-cut sheets. The general or overall size of the blank or bulk substrate 102 may be at least partially larger than the usable substrate 104, the usable excess substrate 120 and/or the excess substrate 118, etc., which are further defined and referred to at FIG. 2, FIG. 4B.

FIG. 4A illustrates the blank or bulk substrate 102 with lines 116 separating the usable substrate 104 from excess substrate 118. The lines 116 may be cut or punch lines or perforations in the substrate 102. The excess substrate 118 is generally identified in cross hatching. Of course, it is understood that the shape of the usable substrate 104 and/or the excess substrate 118 can vary depending on the specific geometry and structure of the environment in which the substate 104 will be used and/or the type of comfort system 100 that will be made from the substrate 102 and/or according to specific comfort system functions.

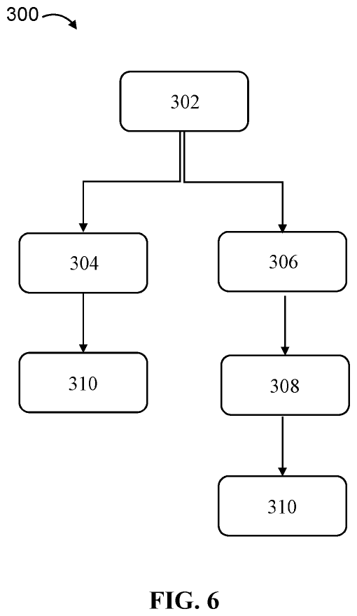

With additional reference to FIG. 6, which illustrates a method 300 according to these teachings, one or more separating steps 302 may be applied to the substrate 102 where the usable substrate 104 is separated from the excess substrate 118. The one or more separating steps 302 may include: cutting, laser cutting, stamping, punching, tearing, ripping, puncturing, perforating, machining, or otherwise separating. After the one or more separating steps 302 and/or after the usable substrate 104 is separated from the excess substrate 118, the exemplary remaining usable substrate 104 is illustrated in FIG. 4B. The usable substrate 104 may undergo one or more additional forming steps 304, where the usable substrate 104 is further processed into the comfort system. For example, the one or more forming steps 304 may include attaching one or more components or elements to the substrate 104 to form the comfort system 100; connecting the substrate 104 to a controller or computer; etc. and/or one or more subsequent separating steps 302 Referring now to FIG. 4C, some of the excess substrate 118 that was separated from the substrate 102 during the one or more separating steps 302 may be repurposed or reclaimed into usable excess substrate 120. After the one or more separating steps 302, the usable excess substrate 120 may optionally be further processed in a further processing step 306 where the usable excess substrate 120 is cut, shaped, or otherwise altered for use in another comfort system 200. Of course, this step 306 is optional if the usable excess substrate 120 is already cut, formed, or shaped into a desirable shape or geometry for the second comfort system 200 during the step 302.

Referring now to FIG. 4D, the method 300 includes a forming step 308, where the usable excess substrate 120 is further processed or incorporated into another comfort system 200. For example, the one or more forming steps 308 may include attaching one or more elements or components 202 to the usable excess substrate 120; connecting the usable excess substrate 120 to a controller or computer; etc. In the case the comfort system 200 is a pneumatic system, the one or more elements 202 may include one or more bladders, cells tubes, hoses, and the like. In the case the comfort system 200 is a thermal system, the one or more elements may include one or more heating conductors to generate heat, one or more elements to generate cooling, or both. In the case the comfort system 200 is a ventilated system, the one or more elements may include using the excess substrate to create one or more air distribution systems, one or more bag structure, attach one or more air movers, etc.

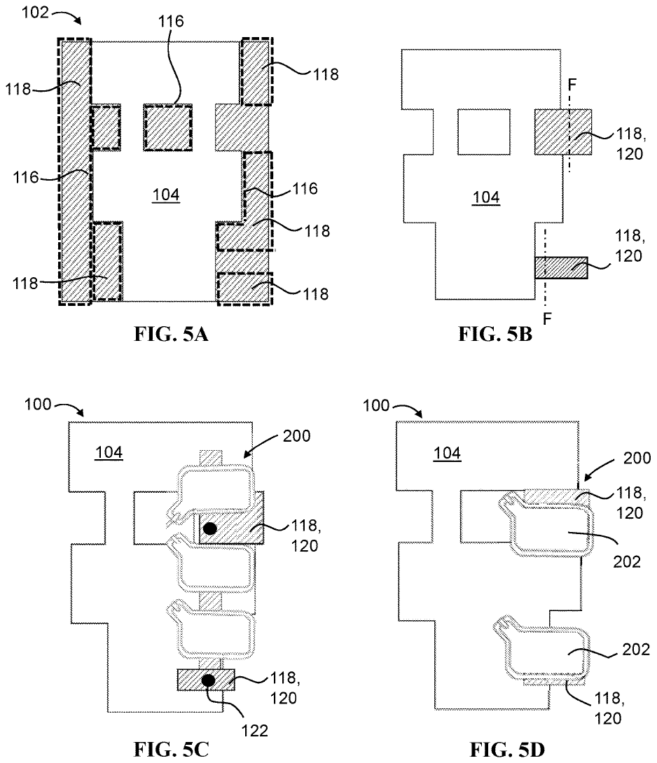

FIG. 5A illustrates the blank or bulk substrate 102 with lines 116 separating the usable substrate 104 from excess substrate 118. The excess substrate 118 is generally identified in cross hatching. Of course, it is understood that the shape of the usable substrate 104 and/or the excess substrate 118 can vary depending on the specific geometry and structure of the environment in which the substate 104 will be used and/or the type of comfort system 100 that will be made from the substrate 102.

With additional reference back to FIG. 6, which illustrates a method 300 according to these teachings, the blank substrate 102 may be exposed to one or more separating steps 302 where at least some of the usable substrate 104 is separated from the excess substrate 118. After the one or more separating steps 302, the remaining usable substrate 104 is illustrated in FIG. 5B. However, some of the usable excess substrate 120 remains attached or connected to the usable substrate 104. In other words, rather than separating all the excess substrate 118 from the usable substrate 114, some of the excess substrate 118, some of the usable excess substrate 120, is not separated from the usable substrate 104 but remains attached to the substrate 104.

Additionally, or alternatively, some of the excess substrate 118 and/or usable excess substrate 120 may be separated and then subsequently attached to the usable substrate 104 via one or more forming steps 308. For example, one or more fasteners or fastening methods may be used to join or attach the usable substrate 104 and the usable excess substrate 120.

The usable excess substrate 120 may optionally be further processed in the forming step 308, where the usable excess substrate 120 is cut, shaped, or otherwise altered for use in another comfort system 200 or before it is attached to the usable substrate 120.

With continued reference to FIG. 5C, the usable excess substrate 120 may be further formed or processed into the comfort system in the forming step 308. For example, the one or more forming steps 308 may include attaching one or more components to the usable excess substrate 120; connecting the suable excess substrate 120 to a controller or computer; etc. More specifically, referring to both FIG. 5B and FIG. 5C, the usable substrate 120 can be folded upon itself along a fold line F and then used to connect, join, or otherwise hold or support the second comfort system 200, which may be the previously formed comfort system 200 illustrated in FIG. 4. The excess usable substrate 120 of the comfort system 100 may be attached to the excess usable substrate 120 of the comfort system 200 via one or more fasteners 122. The one or more fasteners 122 may include any of the fasteners disclosed herein.

Additionally, or alternatively, referring to FIG. 5D, the method 300 may include a forming step 306, where one or more elements 202 are attached or fixed to the usable excess substrate 120. The one or more elements 202 may be attached to the usable excess substrate 120 via one or more fastening methods and related fasteners such as welds, pins, clips, adhesives, stitches, staples, etc.

The method 300 may include a step of recycling the excess substrate 310 (i.e., the excess substrate 118 that is not repurposed for use in another comfort system 200). This recycling step may include further processing the excess substrate for use in other comfort systems or for use in other applications not related to comfort systems, vehicle seats, and/or vehicles. For example, this step 308 may include using the excess substrate for clothing, shelter, etc.

As would be understood by those having skill in the art, excess substrate 118 may have previously been discarded, which may negatively impact the environment and lead to higher processing costs. However, by repurposing or reusing or reclaiming the excess substrate, less waste may be generated which may result in positively impacting the environment and may lead to lower processing and assembly costs for other applications. This method may be particularly useful for a comfort system manufacturer and/or supplier, which may manufacture and/or assemble various comfort systems. By utilizing excess substrate from one line into another line, a substantial material savings may be realized.

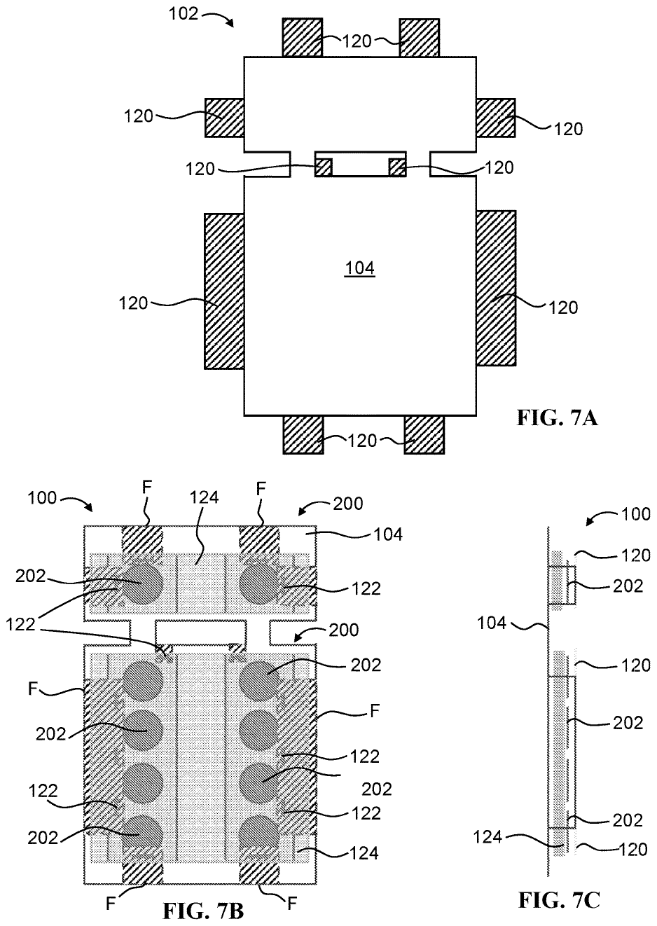

FIGS. 7A-7C illustrate a comfort system that may be substantially similar to the system illustrated and described above at FIGS. 5A-5C. However an additional spacing or padding layer 124 may be provided on or between the substate 104 and the additional comfort system 200. The additional spacing or padding layer 124 may be a plus or plush pad that may help reduce read-through of the air cells at the A-surface of the vehicle seat.

For example, FIG. 7A illustrates the blank or bulk substrate 102, where excess substrate has been removed so that only usable substrate 104 and usable excess substrate 120 remains. This separation may have taken place during the one or more separating steps 302 of method 300 in FIG. 6. As discussed previously, the excess substrate 120 may remain integrally attached to the usable substrate 104 (e.g., no cutting or separation takes place during the one or more separating steps 302). Alternatively, one or more parts of the excess substrate may be separated from the main substrate 102, 104 and then subsequently attached thereto via one or more fasteners or fastening methods.

With reference now to FIG. 7B, in or during one or more steps of the method 300, such as the one or more forming steps 308, a padding layer or support layer 124 may be provided on the substrate 104. Another comfort system 200 may then be provided on the padding layer or support layer 124. The another comfort system 200 may comprise a pneumatic system, lumbar system, massage system 200, like the one illustrated and described at FIG. 4D. The another comfort system may comprise a substrate, which may be substrate (usable excess substrate 120 or another substrate) and one or more elements 202 that may be one or more tubs, hoses, wires, air cells, bladders, etc. supported on the substrate.

The usable substrate 120 can be folded upon itself along a fold line F and then used to connect, join, or otherwise hold or support the second comfort system 200. The excess usable substrate 120 of the comfort system 100 may be attached to the excess usable substrate 120 of the comfort system 200 and/or the padding layer or support layer 124 via one or more fasteners 122. The one or more fasteners 122 may include any of the fasteners disclosed herein, such as for example, welds, pins, clips, adhesives, stitches, staples, welding, ultra sonic welding, heat staking, etc.

The following disclosure relates to all examples disclosed herein without limitation unless otherwise noted.

Reference is made to a carrier or substrate herein. The substrate disclosed herein may be made from any suitable material such as foam, cloth, nylon, polyester, cotton, linen, fabric, vinyl, leather, insulation, a woven or non-woven material; fleece, felt, spun bond material, polyester material, a PET material (polyethylene terephthalate) polyester material, a polyester point bond material, nylon, polymeric material, such as plastics, elastomers, thermoplastics, composites or the like, or a combination thereof. The substrate may be flexible and/or configured to conform to various supporting and/or adjacent geometries of the vehicle, vehicle seat, and/or other adjacent structure. The substrate may also be referred to as a carrier. The substrate may be configured as a base or structure on which elements of the comfort system (i.e., thermal system and/or pneumatic system) are attached or supported.

The blank substrate may be provided as a sheet, strip, or panel. The shape of the substrate may be provided in a myriad of configurations, which may depend on one or more factors such as the vehicle seat design, regions that are intended to be (or not intended to be) temperature controlled (heated and/or cooled) by the comfort system. For example, in some configurations, the substrate may have a simple rectangular or square shape.

These teachings provide a comfort system. The comfort system may be an insert or assembly that comprises one or more or two or more comfort producing functions.

The comfort system may be a thermal system. A thermal system may be configured to provide heating and/or cooling functions or effects to an occupant of a vehicle seat. The thermal system may be of the type and/or may include teachings that are at least partially, or entirely, disclosed in any of the following U.S. Pat. Nos. 11,033,058; 7,560,670; 7,285,748; 7,223,948; 6,838,647; 6,710,303; 6,150,642; 5,451,747; 4,931,627; 4,777,351; U.S. Patent Publication Nos. 20200406797, 20200025424 and/or 2010/0289303, all of which are expressly incorporated herein by reference for all purposes. The thermal system may be a cooling mat that may include one or more cooling elements. The one or more cooling elements may be one or more graphite/graphene strips, as disclosed in U.S. Pat. No. 11,033,058 and US Publication US20200025424A1, both of which are incorporated by reference for all purposes. The thermal system may be a heating mat that may include one or more heating elements. The one or more heating elements may be one or more wires or conductors that are arranged on, below, and/or are integrated into the substrate. The shape of the one or more heating elements may be provided in a myriad of configurations, which may also depend on one or more factors like the vehicle seat design. For example, the one or more heating elements may be a resistive wire that winds, meanders, zigzags, etc. on the substrate. The one or more heating elements may be configured to be supplied with power from a power source and then generate heat in response to the power supply. The heat may warm the surface of the vehicle seat and thus provide warmth to an occupant.

The comfort system may be an air distribution system that has a bag-like structure. Such an air distribution system may be in fluid communication with an air mover or fan to push air through the air distribution system and towards an occupant in the vehicle seat and/or draw air into the air distributions system away from the occupant in the vehicle seat. For example, the air distribution system may be of the type disclosed in U.S. Pat. Nos. 6,869,140B2 and/or 7,862,113B2, the entries of which are hereby incorporated by reference herein for all purposes.

The comfort system may be a pneumatic system. A pneumatic system may be configured to provide lumbar and/or massage functions to an occupant of a vehicle seat. The pneumatic system may be of the type disclosed in U.S. Patent Publication No. US2012/0313420, U.S. Pat. No. 10,906,442 B2, and/or US21013/0127226, all of which is expressly incorporated by reference herein for all purposes.

The comfort system may be a combination of two or more of any of the comfort systems disclosed herein.

The comfort system may have one or more elements attached to the substrate. In the case of a thermal system, the one or more elements may include one or more heating or resistive elements, wires, resistors, temperature sensors, copper wires, electrical wires, etc. In the case of a pneumatic system, the one or more elements may include one or more bladders or air cells. The one or more bladders or air cells may be configured to be inflated and deflated with air or other fluid to adjust a contour, size, and/or shape of the air cells to provide a comfort function (e.g., massage, lumbar, etc.). The air, fluid, or gas may be supplied to the one or more air cells via one or more fluid sources, such as pumps, actuators, inflators, tanks, the like, or a combination thereof, that are connected to the one or more air cells via one or more hoses. The pneumatic system may be a massage system, a lumbar system, or both.

In some configurations, the substrate, the excess usable substrate, or both may be used as a spacer layer, padding layer, etc. A spacer layer may function to reduce read through or visibility of one or more elements or components of the comfort system through an A-surface of the vehicle seat. The spacer layer may function to provide additional padding and or support to an occupant in the vehicle seat. The spacer layer may be sufficiently thick to provide padding and additional comfort to the occupant and reduce read through of any of the comfort functions through an A-side of the vehicle seat, however, to not interfere with any massage or lumbar functions of the massage system. The spacer layer may function to change modify the feel of the seat, increase, or decrease an intensity of the massage or lumbar functions of the massage system that is seen and/or felt by an occupant, or both. The spacer layer may be an air permeable material or layer. The spacer layer may function to facilitate an even distribution of air flow. The spacer layer may be an air impermeable material or layer. The spacer layer may be made of a cloth, fleece, and/or felt material, spun bond material, polyester material, a PET material (polyethylene terephthalate), a foam, a plush foam, or a combination thereof. The spacer layer may be felt or similar, or spacer fabric such as that supplied by Mueller Textile of Germany. The spacer layer may be configured to generally retain its three-dimensional shape when subjected to compressive and/or other types of forces. The spacer layer may include internal pores or passages that permit air or other fluid to pass therethrough. For example, the spacer layer can comprise an internal lattice or other structure which has internal openings. The spacer layer may be a screen or a mesh. The spacer layer may be compressible, elastic, resilient, or a combination thereof. The spacer layer may be breathable, resistant to crush, and/or made from a foam, plastic, and/or polymeric material. The spacer layer may have sufficient resiliency to prevent crushing of spacer layer when an occupant sits on or leans back against the vehicle seat. The spacer layer may include upper netting layer, a lower netting layer and a plurality of fibers extending between them. The spacer or padding layer may be a pad, plush pad, plus pad, or a combination thereof.

Reference is made herein to using one or more fasteners herein. The one or more fasteners may be used for attaching or connecting the one or more air bladders to the carrier of the pneumatic system; for attaching or connecting one or more air cells or carrier of the pneumatic system to thermal system or one or more mats or layers of the thermal system; for connecting or attaching the comfort system to the vehicle seat or seat foam; for attaching or connecting two or more carriers and/or spacer or padding layers, for connecting any of the components or elements disclosed herein, etc.

The one or more fasteners may be or may include one or more fastening components and/or fastening methods that include: lamination, tape, double-sided adhesive tape, peel and stick tape, single sided adhesive tape, pressure sensitive adhesive, glues, epoxies, spray on adhesives, hog rings, stitching, sewing, welding, high-frequency welding, IR welding, RF welding, ultrasonic welding, ultra sonic welding, sealing, heat sealing, heat staking, chemical fixation, hook and loop fasteners, staples, rivets, pins, buttons, snaps, bands, straps, tag pins (plastic, cloth, etc.), or a combination thereof.

A method is disclosed herein. It is understood that one or more of the method steps disclosed herein may be omitted, duplicated, combined with one or more steps, rearranged, separated into two or more steps, or a combination thereof.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a motor” does not limit the teachings to a single motor. Instead, for example, disclosure of “a motor” may include “one or more motors.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein may suitably be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be or may not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### LISTING OF REFERENCE NUMERALS

10 vehicle
12 vehicle seat
14 seating portion
16 backrest portion
18 cushion
20 upper or front region of cushion 18
22 lower or bottom region of the cushion 18
24 bolster region of the cushion 18
26 trench of the cushion 18
28 through holes in the cushion 18
100 comfort system
102 blank substrate
104 usable substrate
106 upper or front region of substrate 104
108 lower or bottom region of substrate 104
110 bolster region of substrate 104
112 cutouts of substrate 104
114 through holes of substrate 104
116 lines
118 excess substrate
120 usable excess substrate
122 fastener for connecting comfort system 200 to 100
124 padding or support layer
200 another comfort system
202 elements of second comfort system 200
300 method
302 separating step
304 forming step
306 optional further processing step
308 Forming step
310 Recycling

1.-17. (canceled)

18. A comfort assembly comprising:
a first comfort system comprising a first substrate including an excess substrate extending outwardly from a perimeter of the first substrate;
a second comfort system comprising a second substrate;
wherein the excess substrate is folded over a region of the second substrate and secured to the second substrate to couple the first comfort system and the second comfort system.

19. The comfort assembly of claim 18, further comprising a padding layer positioned between the first substrate and the second substrate.

20. The comfort assembly of claim 19, wherein the excess substrate is fastened to the padding layer.

21. The comfort assembly of claim 20, wherein the first comfort system is a thermal comfort system.

22. The comfort assembly of claim 21, wherein the second comfort system is a pneumatic comfort system comprising one or more bladders or air cells.

23. The comfort assembly of claim 22, wherein the second substrate comprises repurposed substrate obtained during manufacture or assembly of the first comfort system.

24. The comfort assembly of claim 18, wherein the excess substrate is integrally formed with the first substrate.

25. The comfort assembly of claim 24, wherein the excess substrate comprises one or more fold tabs.

26. The comfort assembly of claim 25, wherein a fold line for each fold tab is located at a perimeter of the first substrate.

27. The comfort assembly of claim 18, wherein the excess substrate is attached to the first substrate via one or more fasteners.

28. The comfort assembly of claim 27, wherein the one or more fasteners comprise adhesive, stitching, mechanical fasteners, heat staking, or welding.

29. The comfort assembly of claim 28, wherein the fasteners secure the excess substrate after folding over the second comfort system.

30. The comfort assembly of claim 18, wherein the excess substrate is configured to wrap around an outer perimeter region of the second substrate.

31. A vehicle seat comprising the comfort assembly according to claim 18.

32. A method of forming a comfort assembly, comprising:
providing a first comfort system comprising a first substrate having an excess substrate extending outwardly from the first substrate;
providing a second comfort system comprising a second substrate; and
folding the excess substrate of the first substrate over at least a portion of the second substrate to couple the first comfort system to the second comfort system.

33. The method of claim 32, comprising positioning a padding layer between the first substrate and the second substrate and fastening the excess substrate to the padding layer.

34. The method of claim 33, wherein the excess substrate is integrally formed with the first substrate, and folding includes bending the excess substrate along a fold line disposed at a perimeter of the first substrate.

35. The method of claim 34, wherein the excess substrate comprises one or more fold tabs, and further comprising securing the fold tabs to the second substrate using one or more fasteners selected from adhesive, stitching, mechanical fasteners, heat staking, or welding.

36. The method of claim 35, comprising installing the comfort assembly in a vehicle seat.
